(19) United States
(12) Patent Application Publication
(10) Pub. No.: US 2026/0084771 A1
(43) Pub. Date: Mar. 26, 2026

(54) ELECTRONIC STABILITY SYSTEM FOR A VEHICLE AND VEHICLE HAVING THE SAME

(71) Applicant: BOMBARDIER RECREATIONAL PRODUCTS INC., Valcourt (CA)

(72) Inventors: Simon BLANCHETTE, Sherbrooke (CA); Yoann ROBIN, Valcourt (CA)

(21) Appl. No.: 19/301,231

(22) Filed: Aug. 15, 2025

Related U.S. Application Data
(60) Provisional application No. 63/684,763, filed on Aug. 19, 2024.

(51) Int. Cl. B62J 9/14; B60T 7/12; B60T 8/1755; B62J 11/00; B62J 45/20; B62J 45/42

(52) U.S. Cl. CPC B62J 9/14; B60T 7/12; B60T 8/1755; B62J 11/00; B62J 45/20; B62J 45/42

(57) ABSTRACT

A vehicle, electronic stability system assembly, and a method of controlling said vehicle. The vehicle having a frame with at least two ground engaging members, a motor operatively connected to at least one of the at least two ground engaging members, and a driver straddle seat supported by the frame. An accessory anchor is connected to the frame rearward of the driver straddle seat and is moveable between a stowed position and a deployed position for selectively connecting to a vehicle accessory. The vehicle further includes an accessory anchor position sensor for sensing a position of the accessory anchor. An electronic stability system (ESS) is communicatively connected to the accessory anchor position sensor for receiving a signal from indicative of the position of the accessory anchor. An output of the ESS controls stability of the vehicle and is defined in part on the signal from the accessory anchor position sensor.

### CROSS REFERENCE

The present application claims priority to the U.S. Provisional Patent Application No. 63/684,763, filed on Aug. 19, 2024, entitled “ELECTRONIC STABILITY SYSTEM FOR A VEHICLE AND VEHICLE HAVING THE SAME”, incorporated by reference herein in its entirety.

### FIELD OF TECHNOLOGY

The present technology relates to vehicle having an electronic stability system.

### BACKGROUND

Vehicles with straddle seats are highly valued for their compact size, making them easy to maneuver in tight spaces. This includes urban settings where parking is limited, as well as off-road environments such as forests. These vehicles encompass, but are not limited to, two-wheel motorcycles, three-wheel on-road vehicles, and four-wheel all-terrain vehicles (ATVs).

Straddle seats often include a removable passenger seat portion designed to accommodate a passenger. This seat is typically positioned rearward, and sometimes higher, than the driver's seat, which naturally shifts the vehicle's center of gravity. To address this shift, many straddle seat vehicles are equipped with electronic stability systems (ESS) and passenger detection sensors that automatically adjust the vehicle's dynamics, ensuring stability during operation with a passenger present.

In some instances, the passenger seat portion can be removed and replaced with a storage container, such as a cargo, to increase the vehicle's carrying capacity. When fully loaded, the storage container can significantly alter the vehicle's center of gravity. However, without a passenger present, the ESS, which relies on passenger detection, will not activate, failing to compensate for the change in weight distribution caused by the storage container. This can compromise the vehicle's stability.

In view of the foregoing, there is a need for an electronic stability system for a vehicle that addresses at least some of these drawbacks.

### SUMMARY

It is an object of the present technology to ameliorate at least some of the inconveniences present in the prior art.

According to an aspect of the present technology, there is provided a vehicle. The vehicle includes a frame; at least two ground engaging members attached to the frame; a motor operatively connected to at least one of the at least two ground engaging members; a driver straddle seat supported by the frame; an accessory anchor connected to the frame rearward of the driver straddle seat, the accessory anchor being moveable between: a stowed position; and a deployed position for selectively connecting to a vehicle accessory; an accessory anchor position sensor for sensing a position of the accessory anchor; and an electronic stability system communicatively connected to the accessory anchor position sensor for receiving a signal from the accessory anchor position sensor indicative of the position of the accessory anchor, an output of the electronic stability system for controlling a stability of the vehicle being defined at least in part on the signal from the accessory anchor position sensor.

In some embodiments, in response to the signal from the accessory anchor position sensor being indicative of the accessory anchor being in the stowed position, the output of the electronic stability system being based on a first calibration value; and in response to the signal from the accessory anchor position sensor being indicative of the accessory anchor being in the deployed position, the output of the electronic stability system being based on a second calibration value.

In some embodiments, the motor is controlled at least in part based on the output of the electronic stability system to adjust the stability of the vehicle.

In some embodiments, the vehicle further includes a braking system including at least one brake assembly operatively connected to at least one of the at least two wheels; and the braking system is controlled at least in part based on the output of the electronic stability system to adjust the stability of the vehicle.

In some embodiments, the accessory anchor is a first accessory anchor connected to a first side of the frame; and the vehicle further includes a second accessory anchor connected to a second side of the frame, the second side being opposite to the first side.

In some embodiments, the frame defines an interior volume positioned rearward of the driver straddle seat; when in the stowed position, the accessory anchor is stowed within the interior volume; and when in the deployed position, at least a portion of the accessory anchor is deployed outside the interior volume.

In some embodiments, the vehicle further includes a cover configured to support the vehicle accessory for selectively covering the interior volume.

In some embodiments, the cover is removably connected to the frame.

In some embodiments, the cover includes: a body having a bottom surface; and a cover interlocking feature connected to the bottom surface at a first end of the body; and the frame includes a frame interlocking feature configured to engage with the cover interlocking feature to removably connect the cover to the frame.

In some embodiments, the cover interlocking feature includes: a pair of protrusions extending away from the bottom surface of the cover and spaced apart from one another; and a rod extending in between the pair of protrusions; and the frame interlocking feature includes a hook configured to receive the rod.

In some embodiments, the cover includes: an extension connected to the body at a second end of the body and extending away from the bottom surface, the second end being opposite the first end; and a projection connected to the extension and extending laterally away from the extension, the projection being configured to engage with a portion of the driver straddle seat.

In some embodiments, the portion of the accessory anchor defines an aperture; and the vehicle further includes the vehicle accessory, the vehicle accessory having a latch configured to be received in the aperture, the latch being moveable between an unlocked position; and a locked position, in which the vehicle accessory is coupled to the attachment arm.

In some embodiments, the vehicle accessory is a cargo disposed over the interior volume when connected.

In some embodiments, the accessory anchor includes an attachment arm; and the accessory anchor position sensor is an attachment arm position sensor.

In some embodiments, the attachment arm includes a magnet; the attachment arm position sensor is a Hall Effect sensor positioned within the interior volume; and the attachment arm and the attachment arm sensor are arranged and positioned such that: when the attachment arm is in one of the stowed position and the deployed position, the magnet is positioned at a first distance from the Hall Effect sensor, and when the attachment arm is in an other one of the stowed position and the deployed position, the magnet is positioned at a second distance from the Hall Effect sensor, the second distance being less than the first distance.

In some embodiments, when the attachment arm is in the stowed position, the magnet is positioned at the first distance from the Hall Effect sensor, and when the attachment arm is in the deployed position, the magnet is positioned at the second distance from the Hall Effect sensor.

In some embodiments, the frame defines an interior volume positioned rearward of the driver straddle seat; when in the stowed position, the accessory anchor is stowed within the interior volume; when in the deployed position, at least a portion of the accessory anchor is deployed outside the interior volume; and the Hall Effect sensor is positioned within the interior volume.

In some embodiments, the accessory anchor is pivotably connected to the frame.

In some embodiments, the at least two ground engaging members are at least two wheels.

According to another aspect of the present technology, there is provided an electronic stability system assembly for a vehicle. The electronic stability assembly includes an accessory anchor adapted for connecting to a frame of the vehicle and for being moveable between a stowed position; and a deployed position for selectively connecting to a vehicle accessory; an accessory anchor position sensor for sensing a position of the anchor accessory; and an electronic stability system communicatively connected to the accessory anchor position sensor for receiving a signal from the accessory anchor position sensor indicative of the position of the accessory anchor, an output of the electronic stability system for controlling a stability of the vehicle being defined at least in part on the signal from the accessory anchor position sensor.

In some embodiments, in response to the signal from the accessory anchor position sensor being indicative of the position of the accessory anchor being in the stowed position, the output of the electronic stability system, and thereby the stability of the vehicle, being based on a first calibration value; and in response to the signal from the accessory anchor attachment arm position sensor is indicative of the position of the accessory anchor being in the deployed position, the output of the electronic stability system, and thereby the stability of the vehicle, being based on a second calibration.

In some embodiments, the output of the electronic stability system is adapted for controlling at least in part a motor of the vehicle to adjust the stability of the vehicle.

In some embodiments, the output of the electronic stability system is adapted for controlling at least in part a braking system of the vehicle to adjust the stability of the vehicle.

In some embodiments, when in the stowed position, the accessory anchor is stowed within an interior volume defined by the frame of the vehicle; and when in the deployed position, a portion of the accessory anchor is deployed outside of the interior volume.

In some embodiments, the electronic stability system assembly further includes a cover adapted for selectively covering the interior volume and for supporting the vehicle accessory.

According to another aspect of the present technology, there is provided a method for controlling a vehicle, the method being executed by a controller of the vehicle. The method includes sensing, via an accessory anchor position sensor, a position of an accessory anchor, the accessory anchor being connected to a frame of the vehicle and configured to be moveable between a stowed position; and a deployed position for selectively connecting to a vehicle accessory; defining an output of an electronic stability system of the vehicle based at least in part on the sensed position of accessory anchor; and controlling a stability of the vehicle using the output of the electronic stability system.

In some embodiments, the method further includes in response to the attachment arm being in the stowed position, selecting a first calibration of the electronic stability system; and in response to the attachment arm being in the deployed position, selecting a second calibration of the electronic stability system; wherein the output of the electronic stability system is defined based at least in part on the selected one of the first calibration and the second calibration.

In some embodiments, controlling the stability of the vehicle using the output of the electronic stability system includes controlling an operation of a motor of the vehicle.

In some embodiments, controlling the stability of the vehicle using the output of the electronic stability system includes controlling an operation of a braking system of the vehicle.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

For purposes of this application, terms related to spatial orientation such as forwardly, rearward, upwardly, downwardly, left, and right, are as they would normally be understood by a driver of the vehicle sitting thereon in a normal driving position. Terms related to spatial orientation when describing or referring to components or sub-assemblies of the vehicle, separately from the vehicle should be understood as they would be understood when these components or sub-assemblies are mounted to the vehicle, unless specified otherwise in this application. The phrase “at least one of A and B” should be understood to mean “only A, only B, or both A and B”.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, right side of a vehicle in accordance with an embodiment of the present technology;

FIG. 2 is a right side elevation view of the vehicle of FIG. 1;

FIG. 3 is a perspective view taken from a top, rear, left side of a frame of the vehicle of FIG. 1, with a pair of attachment arms in a stowed position;

FIG. 4 is a top plan view of the frame of FIG. 3, with the pair of attachment arms in the stowed position;

FIG. 5 is a cross-sectional view taken along line 5-5 of FIG. 4 of the frame of FIG. 3;

FIG. 6 is a close-up perspective view taken from a top, rear, left side of the frame of FIG. 3;

FIG. 7 is a perspective view taken from a top, rear, left side of the frame of the vehicle of FIG. 1, with the pair of attachment arms in a deployed position;

FIG. 8 is a top plan view of the frame of FIG. 7, with the pair of attachment arms in the deployed position;

FIG. 9 is a cross-sectional view taken along line 9-9 of FIG. 8 of the frame of FIG. 7;

FIG. 10 is a perspective view taken from a top, rear, left side of the frame as arranged in FIG. 7, with a cover connected thereto and the pair of attachment arms in the deployed position;

FIG. 11 is a cross-sectional view taken along line 11-11 of FIG. 10 of the frame of FIG. 7;

FIG. 12 is a schematic diagram depicting a plurality of sensors and a plurality of outputs associated with an electronic stability system of the vehicle of FIG. 1;

FIG. 13 is a logic diagram illustrating a method for controlling a vehicle;

FIG. 14 is a top plan view of the frame of FIG. 7, with the pair of attachment arms in the deployed position and a vehicle accessory arranged to connect with the pair of attachment arms;

FIG. 15 is a cross-sectional view taken along line 15-15 of FIG. 14 of the frame of FIG. 7;

FIG. 16 is a perspective view taken from a bottom, rear, right side of the cover the vehicle of FIG. 1; and

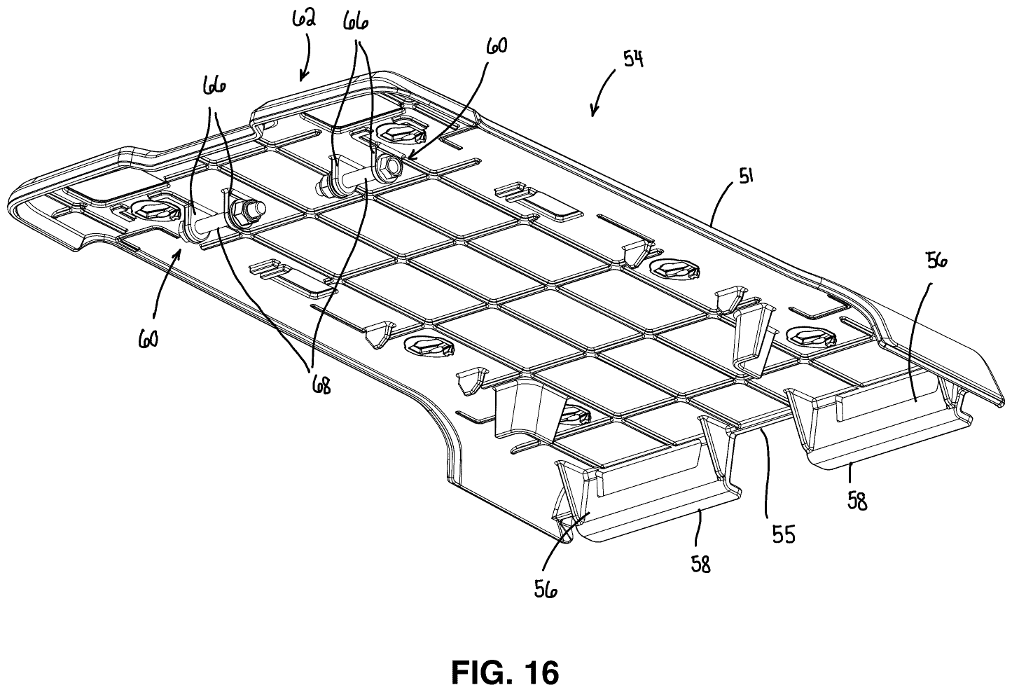

FIG. 17 is a perspective view taken from a top, rear, right side of the vehicle of FIG. 1, with the pair of accessory anchors in the stowed position and a passenger seat portion connected to the frame.

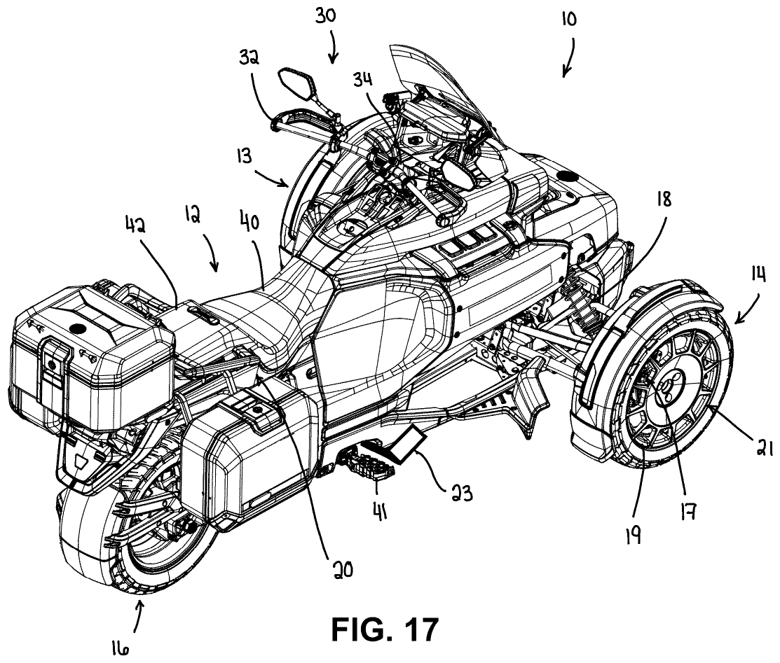

### DETAILED DESCRIPTION

Modifications and improvements to the above-described embodiments of the present technology may become apparent to those skilled in the art. The foregoing description is intended to be exemplary rather than limiting.

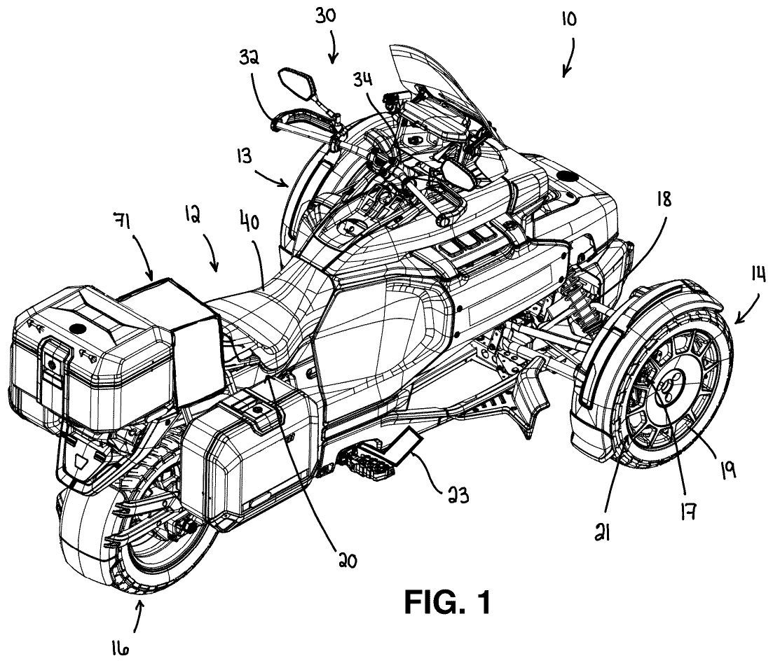

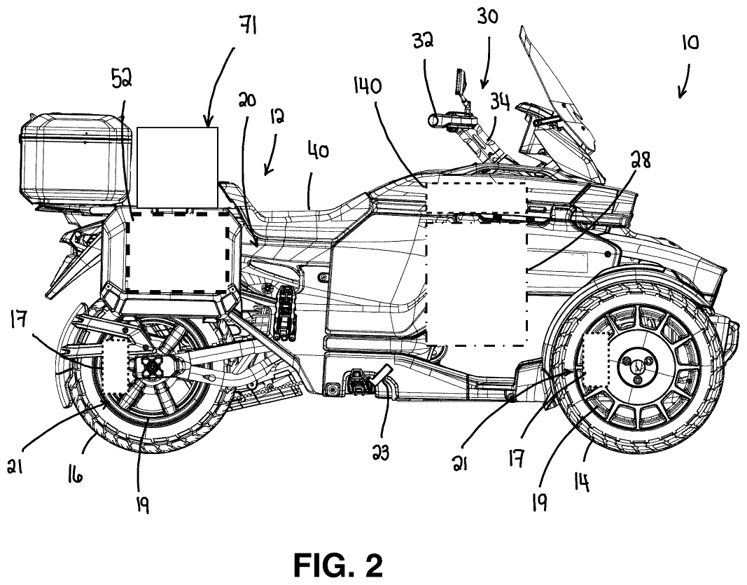

With reference to FIGS. 1 and 2, a vehicle 10 in accordance with one embodiment of the present technology is depicted. The following description relates to one example of a vehicle 10 having a straddle seat 12, specifically a three-wheel vehicle 10, referred to hereinafter as the vehicle 10. It is contemplated that the present technology could be implemented on other wheeled vehicles having a straddle seat, including but not limited to two-wheel motorcycles or four-wheel all terrain vehicles (ATV).

The vehicle 10 has steerable left and right front wheels 13, 14 and a single rear wheel 16. The front wheels 13, 14, are equally offset from a central longitudinal axis of the vehicle 10. The rear wheel 16 is centered between the front wheels 13, 14, aligning with the central longitudinal axis of the vehicle 10. However, it is contemplated that the vehicle 10 may be configured with two rear wheels and a single front wheel. Each front wheel 13, 14 is supported by a front suspension assembly 18. The rear wheel 16 is supported by a rear suspension assembly (not shown). The front suspension assembly 18 and the rear suspension assembly are secured to a frame 20 of the vehicle 10.

Each of the front wheels 13, 14 and the rear wheel 16 is provided with a disk brake assembly 17 (shown schematically in FIG. 2) which form part of a braking system of the vehicle 10. The braking system of the vehicle is a hydraulic braking system, but other types are contemplated. Each disk brake assembly 50 includes a disk mounted to its respective wheel 13, 14, 16 and a brake caliper (not shown). The brake calipers actuate in response to actuation of a brake pedal (not shown). However, it is contemplated that the brake calipers can be actuated alternatively, such as via a hand brake lever mounted to the handlebar 32 or a button on a user interface.

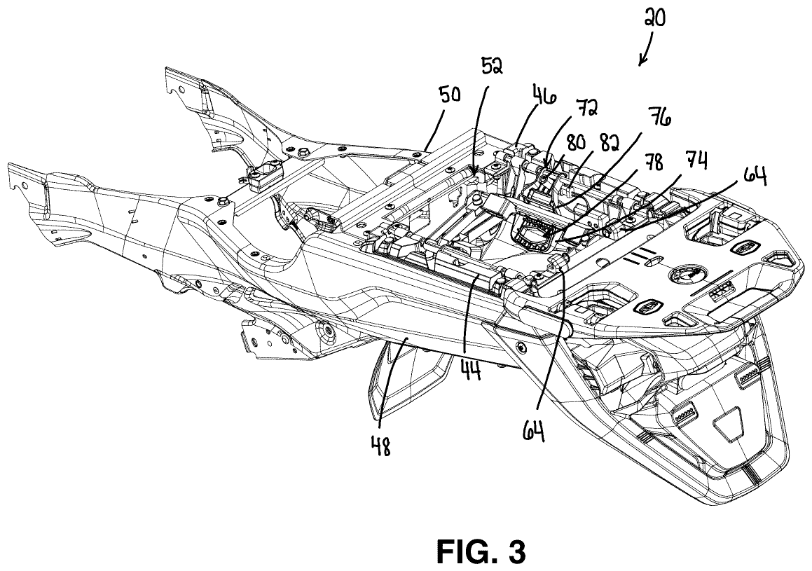

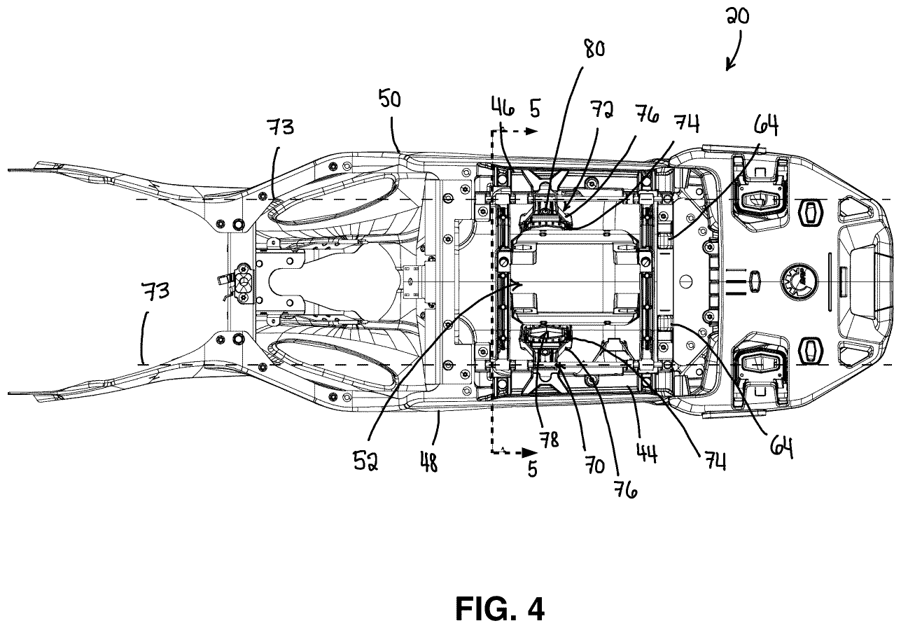

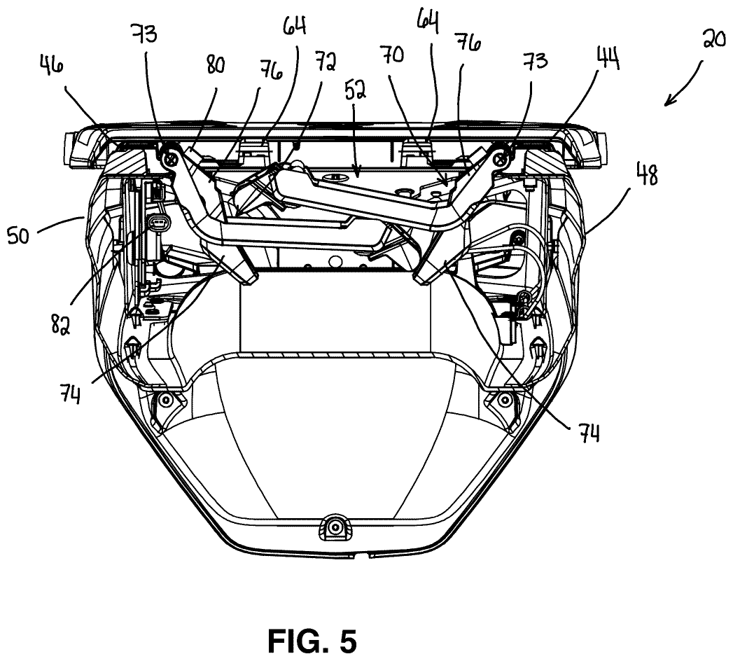

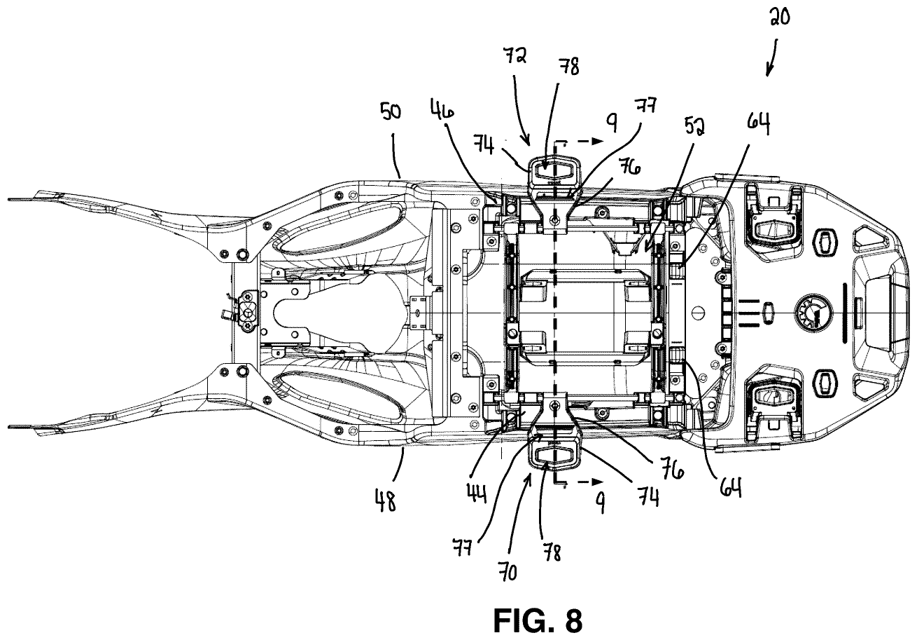

As depicted in FIGS. 3 to 10, 14 and 15, the straddle seat 12 of the vehicle 10 is removably connected to and supported by the frame 20. In this embodiment, the straddle seat 12 includes a driver seat portion 40 for accommodating a driver. A vehicle accessory 71, such as a cargo 71, is positioned rearward of and is higher than the driver seat portion 40. As will be described in detail below, the cargo 71 is removably connected to the vehicle 10. It is noted that, in some instances the cargo 71 may be replaced with a passenger seat portion (not depicted) to accommodate a passenger.

A motor 28 (schematically shown in FIG. 2) is supported by the frame 20. The motor 28 is connected to the rear wheel 16 via a transmission system (not shown) to drive the rear wheel 16. In the present embodiment, the motor 28 is a four-stoke, inline cylinder, internal combustion engine, referred to hereinafter as the engine 28. However, it is contemplated that the motor 28 could have more or fewer cylinders and/or could be any other type of motor, such as a two-stroke, internal combustion engine or an electric motor.

With reference to FIGS. 3 to 9 and 15, the frame 20 defines an interior volume 52 above the rear wheel 16. The interior volume 52 is positioned rearward of the driver seat portion 40 (schematically shown in FIG. 2) and extends laterally between an upper edge 44 of a left panel 48 of the frame 20 and an upper edge 46 of a right panel 50 of the frame 20. It is contemplated that the size and positioning of the interior volume 52 may vary in different embodiments.

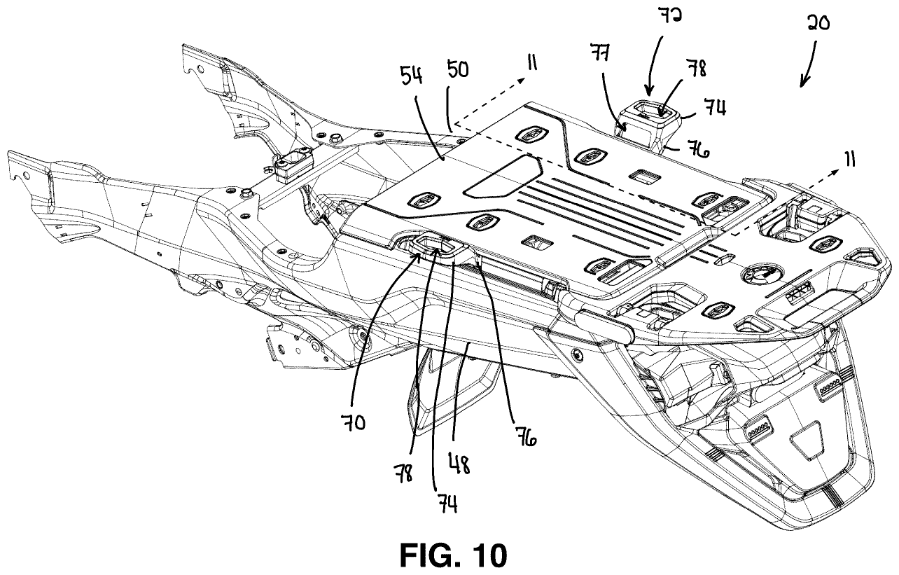

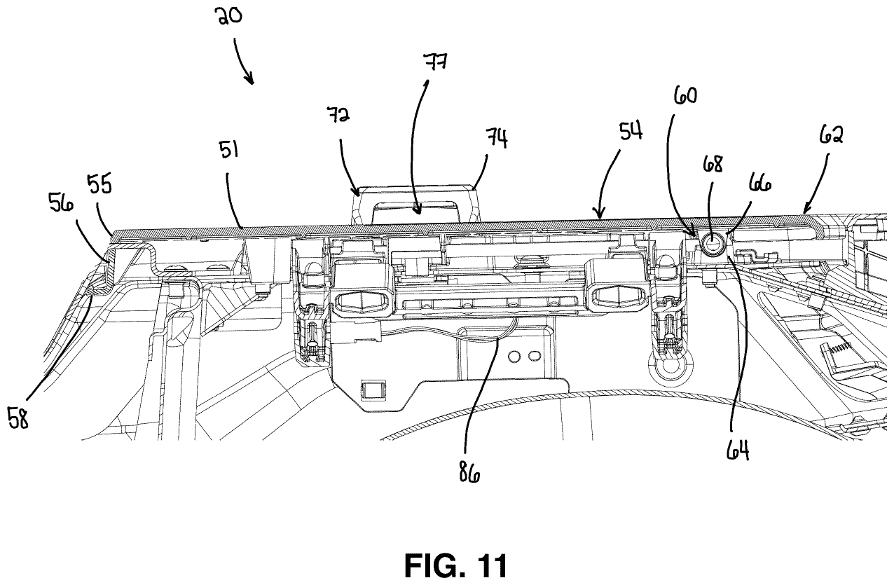

As depicted in FIGS. 10 and 11, the vehicle 10 includes a cover 54 removably connected the frame 20 for selectively covering the interior volume 52. When connected, the cover 54 is disposed rearward of the driver seat portion 40. In alternative embodiments, the cover 54 may be designed differently to allow access to the interior volume 52, for example the cover 54 may be pivotably connected, pivoting between an opened position and a closed position, or the cover 54 may be configured to slide between the opened and closed position.

With specific reference to FIG. 11, the cover 54 will be described in further detail. The cover 54 includes a body 51. The body 51 is substantially planar and is sized and shaped to cover the opening to the interior volume 52.

A left and a right extension 56 (only the right extension 56 being depicted) extend away from a bottom surface of the body 51. In this embodiment, the left and right extensions 56 are positioned at a front end, specifically along a front edge 55, of the body 51. It is contemplated that the number and positioning of extensions 56 may vary in other embodiments.

The left and right extensions 56 have the same configuration and thus, for clarity, only the right extension 56, referred to hereinafter as the extension 56, will be described. A projection 58 extends laterally away from the free end of the extension 56. Specifically, the projection 58 extends away from the body 51 (towards the driver seat portion 40) and substantially parallel to the body 51. When the cover 54 is connected to the frame 20, the projection 58 engages with the driver seat portion 40 to limit forward and vertical translation of the cover 54.

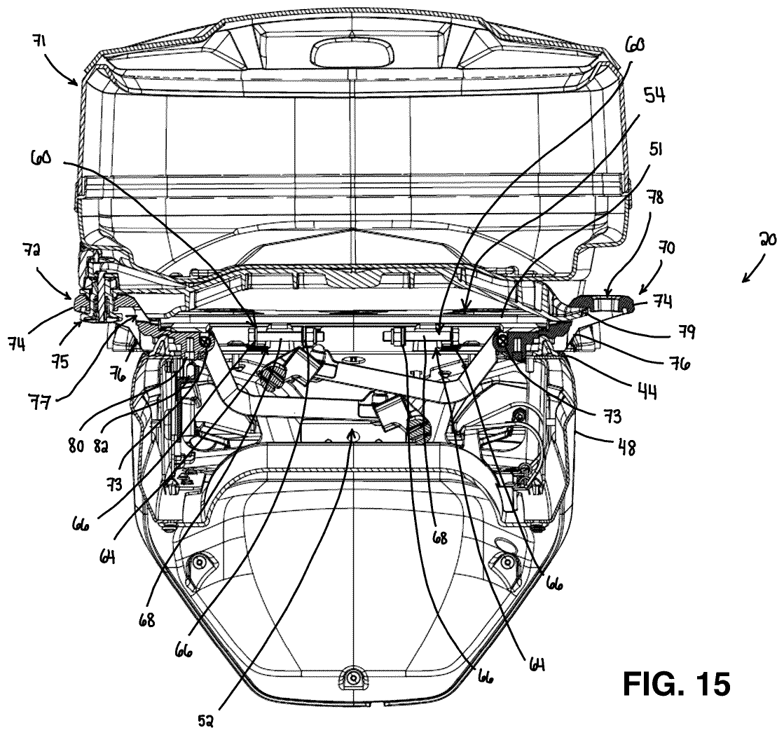

With reference to FIGS. 11 and 15, the cover 54 includes a left and right cover interlocking feature 60 positioned at a rear end 62 of the body 51. The cover interlocking features 60 are configured to engage with a respective frame interlocking feature 64 positioned along a rear upper edge of the frame 20 defining the interior volume 52. That is, the right cover interlocking feature 60 is configured to engage with a right frame interlocking feature 64 while the left cover interlocking feature is configured to engage with a left frame interlocking feature 64. It is contemplated that the number and positioning of the cover and frame interlocking features 60, 64 may vary in other embodiments.

In this embodiment, the left and right cover interlocking features 60 have the same configuration. Similarly, the left and right frame interlocking features 64 have the same configuration. Thus, for clarity, only the right cover interlocking feature 60, referred to hereinafter as the cover interlocking feature 60, and the right frame interlocking feature 64, referred to hereinafter as the frame interlocking feature 64, will be described in detail.

The cover interlocking feature 60 includes a pair of protrusions 66 extending away from the bottom surface of the body 51. The protrusions 66 are spaced apart from one another. Each protrusion 66 defines an opening (not separately numbered) which receives a rod 68, such as a bolt 68, extending therebetween. The bolt 68 is secured on either side via a fastener, such as a nut (not separately numbered).

As depicted in FIGS. 3 to 9 and 15, the frame interlocking feature 64 is a hook 64 configured to receive the bolt 68. Specifically, the hook 64 is oriented such that the cavity of the hook 64 is forward facing, to limit translation of the cover 54 in the rearward direction.

To remove the cover 54, thereby gaining access to the interior volume 52 of the frame 20, the driver seat portion 40 is first removed from the frame 20. Next, the cover 54 is slid in the forward direction to disengage the bolts 58 from the corresponding hooks 64. Once the bolts 58 are disengaged, the cover 54 is then lifted vertically, removing the cover 54 from the frame 20 and providing access to the interior volume 52. Conversely, to install the cover 54 onto the frame 20, covering the interior volume 52. The cover 54 is slid in the rearward direction such that the bolts 58 are received in the cavities of the corresponding hooks 64. The cover 54 is then lowered vertically and the driver seat portion 40 is subsequently installed onto the frame 20.

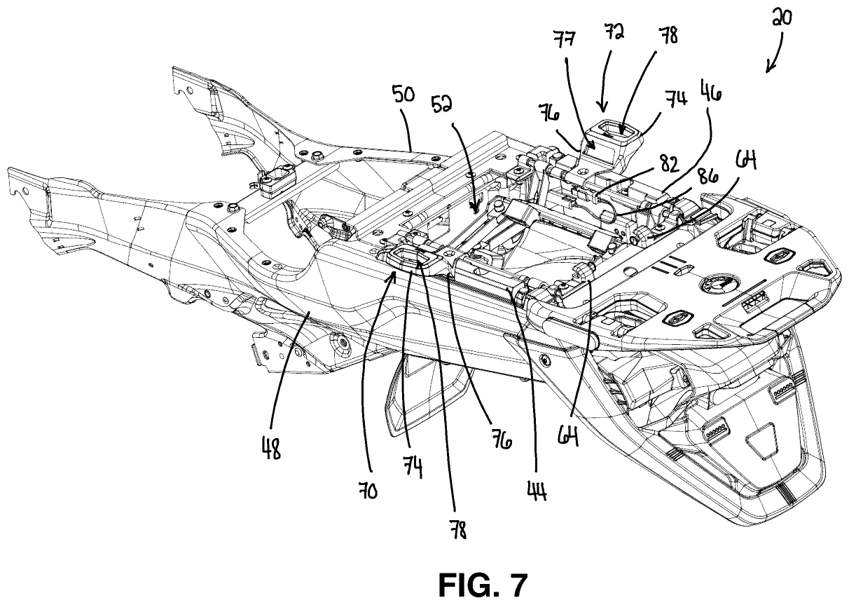

With reference to FIGS. 3 to 9, the vehicle 10 includes a left accessory anchor 70 pivotably connected to a left side of the frame 20 and a right accessory anchor 72 pivotably connected to a right side of the frame 20. Each of the accessory anchors 70, 72 are connected to the frame 20 within the interior volume 52 and pivot about a pivot axis 73 which extends substantially longitudinal to the frame 20. The accessory anchors 70, 72 can be pivoted between a stowed position (as depicted in FIGS. 3 to 6) and a deployed position (as depicted in FIGS. 7 to 10, and 15). It is contemplated that the accessory anchors 70, 72 may be connected to the frame 20 differently in different embodiments.

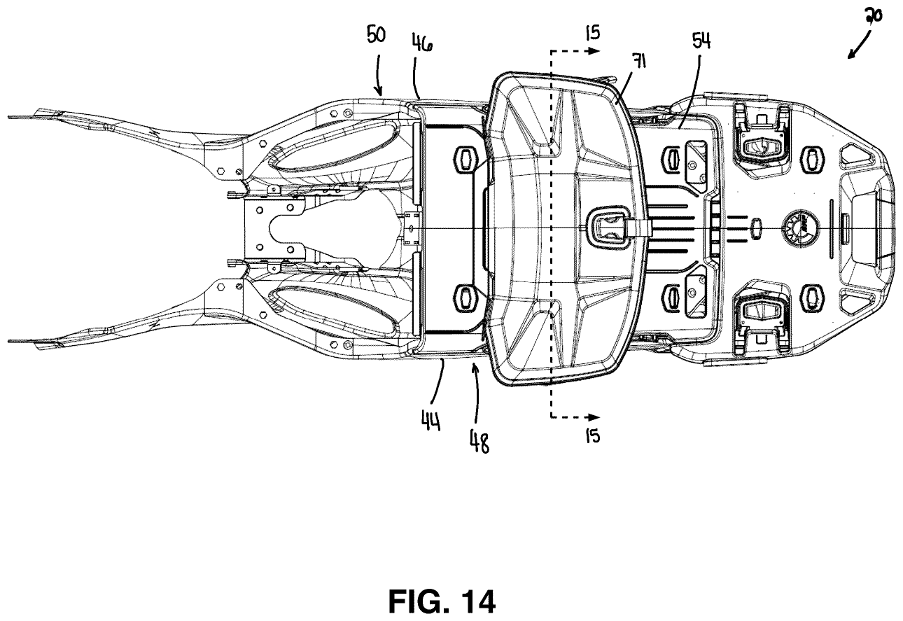

When in the stowed position, the accessory anchors 70, 72 are completely housed within the interior volume 52 of the frame 20. When in the deployed position, a portion of each of the accessory anchors 70, 72 are deployed outside of the interior volume 52 to selectively connect to and support the cargo 71 (as depicted in FIGS. 14 and 15), which is described in detail below. To move the accessory anchors 70, 72 from the stowed position to the deployed position, the accessory anchors 70, 72 are pivoted about the pivot axis 73. Specifically, each of the accessory anchors 70, 72 are pivoted outwardly, away from the central longitudinal axis of the vehicle 10. Conversely, to move the accessory anchors 70, 72 from the deployed position to the stowed position, the accessory anchors 70, 72 are pivoted about the pivot axis 73, with each of the accessory anchors 70, 72 pivoting inwardly, towards the central longitudinal axis of the vehicle 10.

In this embodiment, the left and right accessory anchors 70, 72 are left and right attachment arms 70, 72. However, it is contemplated that the accessory anchors 70, 72 may be configured differently in different embodiments.

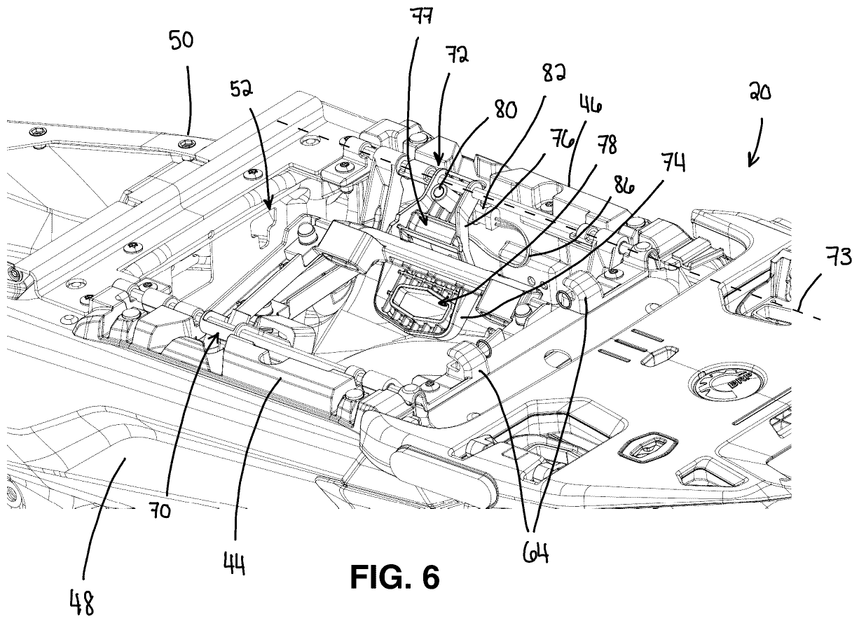

With specific reference to FIGS. 6, 7, 14, and 15, the right attachment arm 72 will now be described. The right attachment arm 72 includes a contact portion 74 that can selectively connect to and support the cargo 71 when the right attachment arm 72 is in the deployed position. In this embodiment, the contact portion 74 defines an aperture 78 for receiving a fastener 75 of the cargo 71 (as depicted in FIG. 15), such as a latch 75 moveable between an unlocked position and a locked position, thereby securing the cargo 71 to the right attachment arm 72. The contact portion 74 extends from a first end of a connecting member 76, with a second end of the connecting member 76 pivotably connecting to the frame 20. The connecting member 76 defines a slot 77. The slot 77 is configured to receive an engageable portion 79, such as a tongue fastener 79 of the cargo 71 (an example of which is depicted in FIG. 15 on the left anchor accessory 70). U.S. Pat. No. 10,850,806, published on Nov. 16, 2017, the entirety of which is incorporated herein by reference, provides more details on the slot 77 and the tongue fastener 79.

When in the stowed position, the entirety of the right attachment arm 72 is housed within the interior volume 52. That is, the contact portion 74 and the connecting member 76 are housed within the interior volume 52. When in the deployed position, the contact portion 74 and a majority of the connecting member 76 are deployed outside of the interior volume 52 while the second end of the connecting member 76 remains within the interior volume 52. In this embodiment, the upper edge 46 of the right panel 50 of the frame 20 defines recesses for receiving a portion of the connecting member 76 when the right attachment arm 72 is deployed. This allows the cover 54 to sit flush onto the frame 20 when covering the interior volume 52. In alternative embodiments, when in the deployed position, the entirety of the right attachment arm 72 may be positioned outside the interior volume 52. The right attachment arm 72 includes a magnet 80 disposed at a bottom side of the connecting member 76 that interacts with an attachment arm position sensor 82 of the vehicle 10, described in detail below.

The left attachment arm 70 has the same configuration as the right attachment arm 72 but for the presence of the magnet 80, and therefore will not be described in detail.

It should be noted that while the left and right attachment arms 70, 72 connect to the cargo 71 differently in the current embodiment, in other embodiments, the cargo 71 may connect to the left and right attachment arms 70, 72 in the same fashion. For instance, the cargo 71 may include two latches 75 with each latch 75 being received in the aperture 78 of the respective attachment arm 70, 72. Alternatively, the cargo 71 may include two tongue fasteners 79 being received in the slot 77 of the respective attachment arm 70, 72.

When the attachment arms 70, 72 are deployed and the cargo 71 is connected to each respective attachment arm 70, 72, the cargo 71 is positioned overtop of the interior volume 52 and supported by the cover 54. That is, the cargo 71 is positioned rearward of the driver seat portion 40. When the cargo 71 is fully loaded, the weight distribution and center of gravity of the vehicle 10 is altered. To compensate for the change in center of gravity, the vehicle 10 is equipped with an electronic stability system (ESS) 140 (shown schematically in FIG. 2) which continuously monitors different vehicle parameters and applies corrective measures to control the stability of the vehicle 10 when the vehicle 10 is approaching an unstable state.

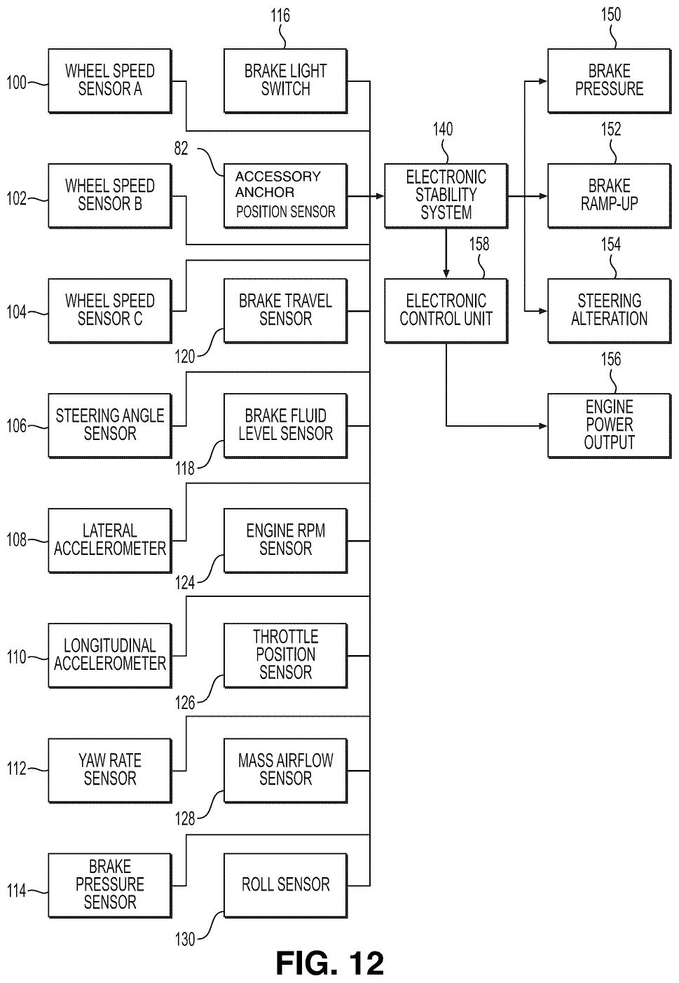

With reference to FIG. 12, the ESS 140 will now be described. The ESS 140 is a computer implemented controller mounted onboard the vehicle 10 and uses predetermined calibrations, disposed in a control map, to determine which outputs (i.e., corrective measures) should be provided given specific inputs, based on the operating conditions of the vehicle 10, one of which is the presence or absence of the cargo 71 connected to the attachment arms 70, 72. The magnitude and timing of the outputs are also managed by the ESS 140 in order to apply the appropriate corrective measures to the vehicle 10. In the present technology, the term calibration is used to describe a mathematical formula, a map, an algorithm, or a value used to determine the outputs of the ESS 140 based on the inputs.

The ESS 140 is dependent on inputs provided by sensors sensing the behaviour of the vehicle 10 to determine the outputs to be generated. A series of sensors can be used for sensing different operating conditions as shown in FIG. 12. The list of sensors provided is for illustrative purposes and is not intended to limit the scope of this application to the listed sensors. Published U.S. patent application number US 2006/0180372A1, published Aug. 17, 2006, the entirety of which is incorporated herein by reference, provides more information about an ESS 140 and related sensors.

In the present implementations, there are three wheel speed sensors 100, 102, 104, one per wheel 13, 14, 16, to sense the speeds of rotation of the wheels 13, 14, 16. A steering angle sensor 106 provides information to the ESS 140 about the angular position of the steering assembly 30 from which can also be determined the steering angle rate (e.g. the speed at which the steering is rotated). Lateral and longitudinal accelerometers 108, 110 are in communication with the ESS 140 and sense the lateral and longitudinal accelerations of the vehicle 10. These accelerometers 108, 110 can be combined with a yaw rate sensor 112 sensing the yaw rate of the vehicle 10 about a vertical axis in addition to longitudinal and lateral accelerations.

A brake pressure sensor 114 informs the ESS 140 of the instant amount of pressure in the braking system. Many brake pressure sensors 114 can be required to monitor different portions of the hydraulic braking system; i.e. the front and rear brake assemblies 17. A brake light switch 116 sends a signal to the ESS 140 when the brakes are activated, even lightly, regardless of the amount of pressure generated in the braking system. A brake fluid level sensor 118 is installed in each brake fluid reservoir on the vehicle 10 and provides information on the brake fluid level to the ESS 140. A brake travel sensor 120, adapted to sense the position of the brake pedal, indicates hard braking from the driver to the ESS 140. The brake travel sensor 120 is activated after the brake light switch 118 to determine, for example, strong intentional brake actuation or extreme brake lever movement due to a loss of brake fluid pressure in the braking system.

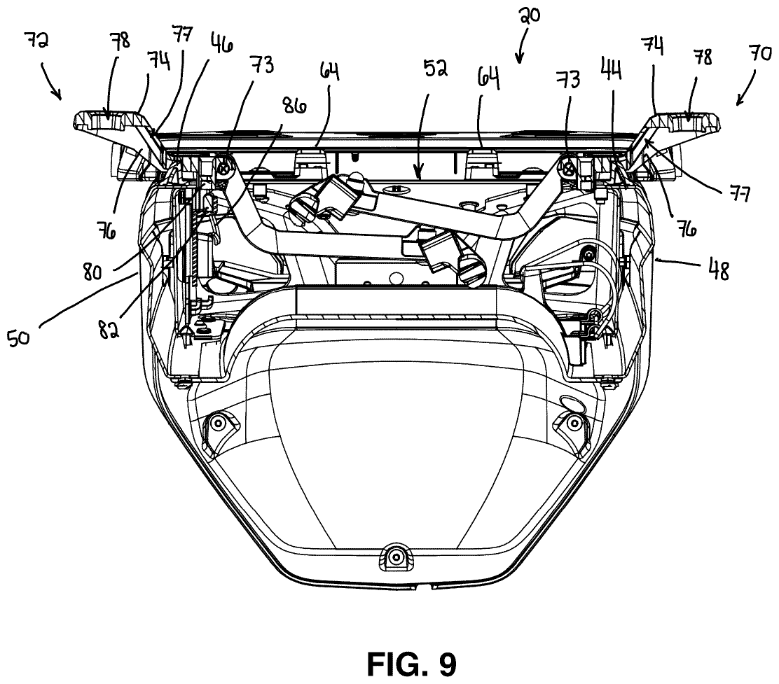

As mentioned above, the vehicle 10 includes the attachment arm position sensor 82. In this embodiment, the attachment arm position sensor 82 is installed within the interior volume 52 on the right side of the frame 20. The attachment arm position sensor 82 senses the position of the right attachment arm 72. The attachment arm position sensor 82 is a Hall effect sensor which senses the change in magnetic field strength due to the position of the magnet 80 on the right attachment arm 72. Specifically, as shown in FIG. 9, when the right attachment arm 72 is in the deployed position, the magnet 80 is proximate to the attachment arm position sensor 81. In contrast, as depicted in FIG. 6, when the right attachment arm 72 is in the stowed position, the magnet 80 is further from the attachment arm position sensor 82. As such, the attachment arm position sensor 82 detects a stronger magnetic field when the right attachment arm 72 is in the deployed position compared to the stowed position. That is, when the right attachment arm 72 is deployed, the magnet 80 is closer to the Hall effect sensor. The magnetic field of the magnet 80 interacts with the Hall effect sensor, which sends a first signal in the form of a first voltage to the ESS 140 via wires 86 indicative that the right attachment arm 72 is in the deployed position. When the right attachment arm 72 is stowed, the magnet 80 is further from the Hall effect sensor such that, when the magnetic field of the magnet 80 interacts with the Hall effect sensor, a second signal in the form of a second voltage is sent to the ESS 140 via the wires 86. The first and second voltages are different from one another.

It is contemplated that the attachment arm position sensor 82 could alternatively be positioned on the left side of the frame 20 to detect the position of the left attachment arm 70. It is further contemplated that, in other embodiments, two attachment arm position sensors 82 could be provided to sense the position of both the attachment arms 70, 72.

An engine RPM sensor 124 informs the ESS 140 of the rotational speed of the engine 28. A throttle position sensor 126 (TPS) determines a degree of opening of the throttle (not shown). A mass airflow sensor 128 indicates how much air is travelling through the throttle.

A roll sensor 130 installed on the vehicle 10 determines a roll angle of the vehicle 10. The roll angle sensed by the roll sensor 130 is compared to a pre-determined roll angle by the ESS 140 for current operating conditions of the vehicle 10.

These sensors can be used individually or collectively to bring inputs usable by the ESS 140 to analyze the operating conditions of the vehicle 10 such that appropriate outputs can be applied to the vehicle 10. It is contemplated that some of the above sensors could be omitted in some embodiments of the vehicle 10. It is also contemplated that alternative or additional sensors could be provided on the vehicle 10 and be used by the ESS 140 as inputs.

Various outputs might be provided by the ESS 140 to influence the behaviour of the vehicle 10. The ESS 140 can send outputs to control the braking system to adjust the stability of the vehicle 10. In some instances, the ESS 140 can send outputs to increase the brake pressure 150 in the braking system, thus forcing braking of the vehicle 10 by overriding manual actuation of the brake pedal by the driver. The ESS 140 can also increase or decrease the brake pressure ramp-up 152. The brake pressure ramp-up 152 is the speed at which the brake fluid pressure is raised to brake the vehicle 10 therefore providing a stronger and faster braking to the vehicle 10. Another output from the ESS 140 could be used to increase or decrease the stiffness 154 of the steering assembly 30 where the steering assembly is provided with a power steering system. The ESS 140 can send outputs to control the engine 28 to adjust the stability of the vehicle 10, such as controlling the power output 156 of the engine 28. Change in the power output 156 of the engine 28 is normally done by the ESS 140 through the electronic control unit 158 (ECU) controlling the engine 28. The ECU 158 electronically modifies, individually or collectively, the ignition timing, the fuel injection timing and the amount of fuel injected in the combustion chamber. The ECU 158 can also modify the degree of opening of the throttle.

The ESS 140 uses predetermined calibrations stored on a computer readable media inside the ESS 140. It is contemplated that the calibration data can be updated by connecting the ESS 140 to a network through a computer to download updated data into the ESS 140. Alternatively, an input/output port (I/O port, not shown) of the ESS 140 can be used to download updated calibrations. Each calibration is used for determining outputs based on the inputs received from at least some of the plurality of sensors.

As previously described, in vehicles such as the vehicle 10, the presence of the cargo 71 rearward of the driver seat portion 40 on the vehicle 10 makes a significant difference on the overall mass and therefore affects the control of the vehicle 10. As such, the ESS 140 affects the vehicle 10 differently depending on the presence or absence of the cargo 71. The ESS 140 according to the present technology uses signals from the attachment arm position sensor 82 to determine if a calibration corresponding to the presence of the cargo 71 rearward of the driver seat portion 40 should be used or if a calibration corresponding to the absence of the cargo 71 rearward of the driver seat portion 40 should be used. If the attachment arm position sensor 82 sends a signal indicative that the right attachment arm 72 is deployed, the ESS 140 selects a calibration corresponding to the presence of the cargo 71. If the attachment arm position sensor 82 sends a signal indicative that the right attachment arm 72 is stowed, the ESS 140 selects a calibration corresponding to the absence of the cargo 71. It is noted that the right attachment arm 72 may be deployed even though the cargo 71 is not in fact present, but the ESS 140 will nonetheless select the calibration corresponding to the presence of the cargo 71.

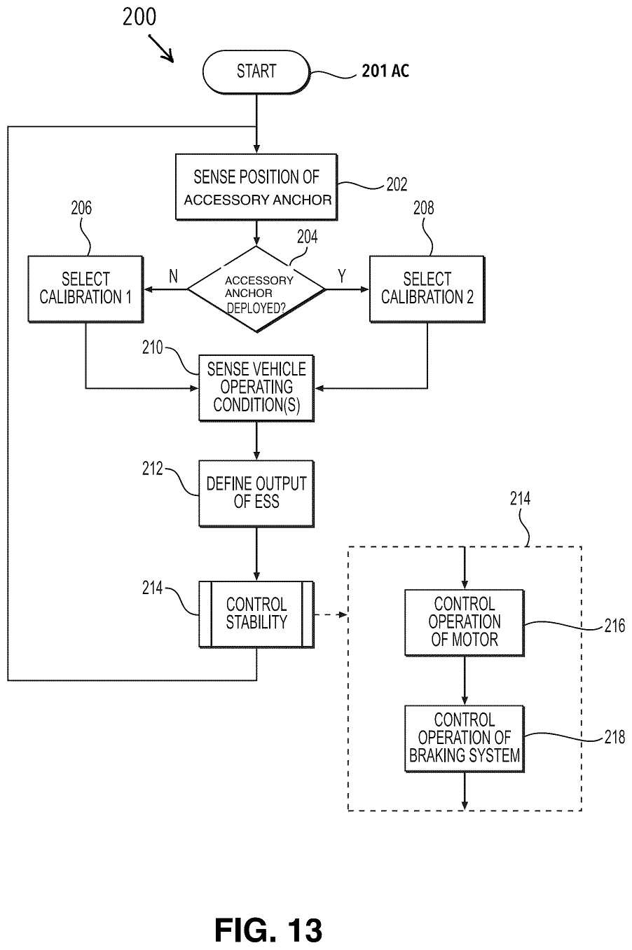

With reference to FIG. 13, a method 200 for controlling the vehicle 10 using the ESS 140 and the attachment arm position sensor 82 will be described. As described above, the attachment arm position sensor 82 is disposed so as to sense the position of the right attachment arm 72, and as such, the method will be described with reference to the right attachment arm 72. It should be understood that method could be performed with the left attachment arm 70 should it be provided with an attachment arm position sensor 82. It is also contemplated that the method could be performed with both attachment arms 70, 72 should both be provided with attachment arm position sensors 82.

The method 200 begins at step 201 when the ESS 140 is turned on. It is contemplated that the method could begin at step 201 only once the ESS 140 is turned on and the engine 28 is running. Then at step 202 the attachment arm position sensor 82 senses the position of the right attachment arm 72 and sends signal representative of this position to the ESS 140. As described previously, in this embodiment the attachment arm position sensor 82 is a Hall effect sensor outputting a voltage that varies according to the position of the right attachment arm 72. The attachment arm position sensor 82 sends the signal to the ESS 140, which in the present implementation is a voltage, that lets the ESS 140 determine if the right attachment arm 72 is in the deployed position or the stowed position. When the right attachment arm 72 is in the deployed position, the attachment arm position sensor 82 sends to the ESS 140 the first signal in the form of the first voltage. The second signal in the form of the second voltage is sent to the ESS 140 when the right attachment arm 72 is in the stowed position. The first and second voltages are different from each other. It is contemplated that any one of the first and second signals could be a null signal, which in the present implementation would correspond to a voltage of zero volt.

From step 202, then at step 204 the ESS 140 determines if the right attachment arm 72 is deployed based on the signal received from the attachment arm position sensor 82 at step 202.

If at step 204 the ESS 140 determines that the right attachment arm 72 is in the stowed position, then the method continues to step 206 and selects a calibration, called for purposes of the present example “Calibration 1”. The calibration “Calibration 1” corresponds to a calibration for the ESS 140 when no cargo 71 is supported by the cover 54 rearward of the driver seat portion 40. If at step 204 the ESS 140 determines that the right attachment arm 72 is in the deployed position, then the method continues to step 208 and selects a calibration, called for purposes of the present example “Calibration 2”. The calibration “Calibration 2” corresponds to a calibration for the ESS 140 when the cargo 71 is present, connected to the attachment arms 70, 72 and supported by the cover 54 rearward of the driver seat portion 40, which is presumed since the right attachment arm 72 is deployed. “Calibration 1” of the ESS 140 is calibrated for an operating mass of the vehicle 10 corresponding to the mass of the vehicle 10 and a pre-determined mass of a driver located on the driver seat portion 40. “Calibration 2” of the ESS 140 is calibrated for an operating mass of the vehicle 10 corresponding to the mass of the vehicle 10, a pre-determined mass of a driver located on the driver seat portion 40 and a pre-determined mass of a fully loaded cargo 71. In an implementation where both attachment arms 70, 72 are provided with attachment arm position sensors 82, it is contemplated that “Calibration 1” would be selected (step 206) if one or both attachment arms 70, 72 are stowed and that “Calibration 2” would be selected (step 208) only if both attachment arms 70, 72 are deployed.

From either one of steps 206 and 208, the method continues at step 210. At step 210, one or more of the operating conditions of the vehicle is/are sensed by the corresponding on or more sensors 100, 102, 104, 106, 108, 110, 112, 114, 116, 118, 120, 124, 126, 128 and 130 discussed above with respect to FIG. 12, which send one or more corresponding signals to the ESS 140.

Then at step 212, based on the signal(s) received at step 210 and the calibration selected at step 206 or 208, the output of the ESS 140 is defined. The output of the ESS 140 determines what corrective actions, if any, need to be taken to help maintain stability of the vehicle 10.

Then at step 214, based on the output of the ESS 140 at step 212 the stability of the vehicle 10 is controlled. As shown in the dotted box to the right of step 214 in FIG. 13, in one implementation this means controlling the operation of the motor (step 216), such as by controlling then engine power output 156, and controlling the operation of the braking system (step 218), such as by controlling the brake pressure 150 and the brake ramp-up 152. It is contemplated that only one of steps 216 and 218 may be performed. It is also contemplated that other actions could be taken such as steering alteration. The control of the stability at step 214 overrides manual inputs by the driver.

From step 214 (or 218 in the specific example provided), the method returns to step 202 to ensure that the position of the right attachment arm 72 has not changed and the method is repeated.

It is contemplated that the calibrations selected at steps 206, 208 could instead be groups of calibrations, with the group of calibrations of alternative step 206 corresponding to calibrations where the right attachment arm is stowed and the group of calibrations of alternative step 208 corresponding to calibrations where the right attachment arm 72 is deployed. Then in a step intermediate steps 210 and 212, the ESS 140 selects a specific calibration from the selected group of calibrations 206 or 208 based on the one or more signals from step 210.

It is also contemplated that the calibrations of steps 206, 208 could be starting calibrations that would then be iterated by the ESS 140 based on actual accelerations and decelerations of the vehicle 10, for example, in order to obtain, over time, a calibration specifically adapted for the actual mass of the vehicle 10, the driver and, if applicable, the cargo 71. For example, the calibration of step 206 would be used as a light start mass calibration (i.e. vehicle 10 and driver only) and the calibration of step 208 would be used as a high start mass calibration (i.e. vehicle 10, driver and cargo 71) in an iterative calibration method similar to the one described in U.S. Pat. No. 9,020,744 .

The above description mentions the left and right attachment arms 70, 72 and the attachment arm position sensor 82 for sensing the position of the right attachment arm 72. However, it is noted that alternative embodiments may incorporate any number and positioning of attachment arms and attachment arm position sensors. Additionally, although the attachment arms 70, 72 have been described as selectively connecting with a cargo 71, it is contemplated that the attachment arms 70, 72 may be connected to other vehicle accessories, such as saddlebags, and/or devices in other embodiments.

It is noted that, although the above description explains that the frame 20 defines the interior volume 52 for housing the accessory anchors 70, 72 in the stowed position, the interior volume 52 may be omitted. For instance, in some embodiments, the accessory anchors 70, 72 may connect to the left and right panels 48, 50 of the frame 20 respectively. The accessory anchors 70, 72 may be configured to deploy from the stowed position (i.e., raised position) and the deployed position (i.e., lowered position). As another example, in some embodiments, the left and right panels 48, 50 may define a left and right cavity for housing the accessory anchors 70, 72 when in the stowed position.

Modifications and improvements to the above-described embodiments of the present technology may become apparent to those skilled in the art. The foregoing description is intended to be exemplary rather than limiting.

What is claimed is:

1. A vehicle comprising:
a frame;
at least two ground engaging members attached to the frame;
a motor operatively connected to at least one of the at least two ground engaging members;
a driver straddle seat supported by the frame;
an accessory anchor connected to the frame rearward of the driver straddle seat, the accessory anchor being moveable between:
a stowed position; and
a deployed position for selectively connecting to a vehicle accessory;
an accessory anchor position sensor for sensing a position of the accessory anchor; and
an electronic stability system communicatively connected to the accessory anchor position sensor for receiving a signal from the accessory anchor position sensor indicative of the position of the accessory anchor, an output of the electronic stability system for controlling a stability of the vehicle being defined at least in part on the signal from the accessory anchor position sensor.

2. The vehicle of claim 1, wherein:
in response to the signal from the accessory anchor position sensor being indicative of the accessory anchor being in the stowed position, the output of the electronic stability system being based on a first calibration value; and
in response to the signal from the accessory anchor position sensor being indicative of the accessory anchor being in the deployed position, the output of the electronic stability system being based on a second calibration value.

3. The vehicle of claim 1, wherein the motor is controlled at least in part based on the output of the electronic stability system to adjust the stability of the vehicle.

4. The vehicle of claim 1, further comprising:
a braking system including at least one brake assembly operatively connected to at least one of the at least ground engaging members; and
wherein the braking system is controlled at least in part based on the output of the electronic stability system to adjust the stability of the vehicle.

5. The vehicle of claim 1, wherein:
the accessory anchor is a first accessory anchor connected to a first side of the frame; and
the vehicle further comprises a second accessory anchor connected to a second side of the frame, the second side being opposite to the first side.

6. The vehicle of claim 1, wherein:
the frame defines an interior volume positioned rearward of the driver straddle seat;
when in the stowed position, the accessory anchor is stowed within the interior volume; and
when in the deployed position, at least a portion of the accessory anchor is deployed outside the interior volume.

7. The vehicle of claim 6, further comprising a cover configured to support the vehicle accessory for selectively covering the interior volume.

8. The vehicle of claim 6, wherein:
the portion of the accessory anchor defines an aperture; and
the vehicle further comprises the vehicle accessory, the vehicle accessory having a latch configured to be received in the aperture, the latch being moveable between:
an unlocked position; and
a locked position, in which the vehicle accessory is coupled to an attachment arm.

9. The vehicle of claim 1, wherein:
the accessory anchor includes an attachment arm; and
the accessory anchor position sensor is an attachment arm position sensor.

10. The vehicle of claim 1, wherein the accessory anchor is pivotably connected to the frame.

11. An electronic stability system assembly for a vehicle comprising:
an accessory anchor adapted for connecting to a frame of the vehicle and for being moveable between:
a stowed position; and
a deployed position for selectively connecting to a vehicle accessory;
an accessory anchor position sensor for sensing a position of the anchor accessory; and
an electronic stability system communicatively connected to the accessory anchor position sensor for receiving a signal from the accessory anchor position sensor indicative of the position of the accessory anchor, an output of the electronic stability system for controlling a stability of the vehicle being defined at least in part on the signal from the accessory anchor position sensor.

12. The electronic stability system assembly of claim 11, wherein:
in response to the signal from the accessory anchor position sensor being indicative of the position of the accessory anchor being in the stowed position, the output of the electronic stability system, and thereby the stability of the vehicle, being based on a first calibration value; and
in response to the signal from the accessory anchor attachment arm position sensor is indicative of the position of the accessory anchor being in the deployed position, the output of the electronic stability system, and thereby the stability of the vehicle, being based on a second calibration.

13. The electronic stability system assembly of claim 11, wherein:
the output of the electronic stability system is adapted for controlling at least in part a motor of the vehicle to adjust the stability of the vehicle.

14. The electronic stability system assembly of claim 11, wherein:
the output of the electronic stability system is adapted for controlling at least in part a braking system of the vehicle to adjust the stability of the vehicle.

15. The electronic stability system assembly of claim 11, wherein:
when in the stowed position, the accessory anchor is stowed within an interior volume defined by the frame of the vehicle; and
when in the deployed position, a portion of the accessory anchor is deployed outside of the interior volume.

16. The electronic stability system assembly of claim 15, further comprising a cover adapted for selectively covering the interior volume and for supporting the vehicle accessory.

17. A method for controlling a vehicle, the method being executed by a controller of the vehicle, the method comprising:
sensing, via an accessory anchor position sensor, a position of an accessory anchor,
the accessory anchor being connected to a frame of the vehicle and configured to be moveable between:
a stowed position; and
a deployed position for selectively connecting to a vehicle accessory;
defining an output of an electronic stability system of the vehicle based at least in part on the sensed position of accessory anchor; and
controlling a stability of the vehicle using the output of the electronic stability system.

18. The method of claim 17, further comprising:
in response to the accessory anchor being in the stowed position, selecting a first calibration of the electronic stability system; and
in response to the accessory anchor being in the deployed position, selecting a second calibration of the electronic stability system;
wherein the output of the electronic stability system is defined based at least in part on the selected one of the first calibration and the second calibration.

19. The method of claim 17, wherein controlling the stability of the vehicle using the output of the electronic stability system comprises controlling an operation of a motor of the vehicle.

20. The method of claim 17, wherein controlling the stability of the vehicle using the output of the electronic stability system comprises controlling an operation of a braking system of the vehicle.
